(19) United States
(12) Patent Application Publication
(10) Pub. No.: US 2010/0012753 A1
(43) Pub. Date: Jan. 21, 2010

(54) FUEL INJECTOR FOR AN INTERNAL COMBUSTION ENGINE

(75) Inventors: Giovanni Corbinelli, Bascharage (LU); Guy Hoffmann, Sandweiler (LU); Didier Robart, Roeser (LU)

Correspondence Address: Delphi Technologies, Inc., M/C 480-410-202, PO BOX 5052, Troy, MI, 48007, US

(73) Assignee: DELPHI TECHNOLOGIES, INC., Troy, MI (US)

(21) Appl. No.: 12/519,892

(22) PCT Filed: Dec. 21, 2007
(86) PCT No.: PCT/EP07/64487

§ 371 Date: Jun. 18, 2009

(30) Foreign Application Priority Data
Dec. 22, 2006 (GB) 0625770.3

(51) Int. Cl. B05B 1/32; F02M 61/10; B21D 51/16

(52) U.S. Cl. 239/453; 239/533.11; 29/890.12

(57) ABSTRACT

A fuel injector comprising an injector body having a spray aperture; a pintle extending within the injector body for axial movement between a closed position and an open position; said pintle head comprising a tapered portion engageable against the valve seat of the spray aperture and a cylindrical portion upstream of said tapered portion, an annular channel being provided defining a first part of a flow passage upstream of the spray aperture, wherein a discontinuity is provided downstream of the annular channel and upstream of the spray aperture to generate cavitation when the pintle stroke exceeds a predetermined limit to thereby generate a virtual channel of constant cross section downstream of the annular channel whereby the flow rate of the fuel flowing through said spray aperture is substantially independent of the stroke of the pintle when the pintle is in its open position.

### TECHNICAL FIELD

The present invention relates to a fuel injector and in particular to a fuel injector for direct injection of gasoline into the combustion chamber of an internal combustion engine.

### BACKGROUND OF THE INVENTION

A typical outwardly opening fuel injector is shown in FIG. 1, comprising, a valve body having a tip portion 2 defining a spray aperture 3, a pintle 4 or valve stem extending within the tip portion 2 for axial movement between an extended and a retracted position, the pintle 4 having a head 5 having a tapered portion 6 engageable with a valve seat 8 of the spray aperture to close the spray aperture 3 when the pintle 4 is in its retracted position, a return spring (not shown) biasing the pintle 4 towards its retracted position, an actuating means (not shown), such as a solenoid or piezostack, acting upon the pintle 4 to urge the pintle 4 to its extended position when the actuating means is energised.

Particularly in the case of solenoid actuated injectors, the pintle opening is limited by an end stop which is typically the top surface of one of the guides.

The flow rate of fuel through the injector is largely dependent upon the gap between the pintle head and the valve seat which is dependent upon stroke of the pintle. For a typical fuel injector having a pintle stroke of between 30 μm and 40 μm and a fuel supply pressure of 200 bar, a 3% variation in the flow rate is experienced for each micron variation in the pintle stroke. Hence there is a high sensitivity to pintle stroke variation, requiring very high manufacturing tolerances of the end stop, pintle and associated components to achieve the required flow rate. Furthermore, variation in the pintle stroke over time due to wear and/or differential thermal expansion can lead to undesirable variation in the fuel flow rate.

### SUMMARY OF THE INVENTION

According to the present invention there is provided a fuel injector comprising an injector body having a spray aperture; a pintle extending within the injector body for axial movement between a closed position, wherein a head of the pintle engages a valve seat of the spray aperture to seal the spray aperture, and an open position, wherein the pintle head is spaced from the valve seat to permit fuel to flow through said spray aperture, actuating means being provided for selectively moving the pintle towards its open position; said pintle head comprising a tapered portion engageable against the valve seat of the spray aperture and a cylindrical portion upstream of said tapered portion, an annular channel being provided defining a first part of a flow passage upstream of the spray aperture, wherein a discontinuity is provided downstream of the annular channel and upstream of the spray aperture to generate cavitation when the pintle stroke exceeds a predetermined limit to thereby generate a virtual channel of constant cross section downstream of the annular channel whereby the flow rate of the fuel flowing through said spray aperture is substantially independent of the stroke of the pintle when the pintle is in its open position.

Preferably said annular channel is defined between a substantially cylindrical portion of the pintle and a concentric portion of the injector body.

The discontinuity may be provided on the pintle head between the cylindrical portion and the tapered portion thereof. Alternatively, the discontinuity may be provided on the injector body between the concentric portion thereof and the valve seat. The discontinuity may comprise a chamfered or stepped surface or any other suitable structure leading to detachment of the flow from a surface of the annular channel.

By providing a discontinuity between the cylindrical portion and the tapered portion of the pintle head a virtual channel of constant cross-section is created between the tapered portion and the valve seat to provide a constant flow velocity substantially independent of the pintle stroke, preventing flow deceleration due to stroke variations and avoiding energy losses downstream of the annular channel. By causing fuel cavitation upstream of the tapered portion of the pintle head, the maximum flow rate through the spray aperture can be made substantially independent of the maximum stroke of the pintle. The required maximum flow rate can be calibrated for a particular application by appropriate selection of the relative dimensions of the discontinuity, the clearance between cylindrical portion between the pintle head and the valve body and the stroke.

The fuel is channelled and accelerated in the first part of the flow passage between the cylindrical portion of the pintle head and the valve body. The flow of liquid fuel detaches from the valve body at the discontinuity, creating a low pressure region wherein the fuel cavitates (i.e. the local pressure falls below the vapour pressure of the fuel such that the liquid fuel becomes a vapour). The cavitation takes place in a flow area which is dependent on pintle stroke, therefore the cavitation zone is self adjusting and gets larger with increasing pintle stroke to maintain a constant effective flow area of liquid fuel, such that static pressure is not recovered and the flow of fuel does not decelerate.

By contrast, in a typical injector nozzle having a cylindrical metering region upstream of a tapered sealing portion, the flow area of the sealing band increases with increasing pintle stroke, causing the flow velocity to decrease and causing a loss of energy and affecting spray atomisation. In the present invention, the creation of a self adjusting cavitation bubble downstream of the cylindrical portion creates a virtual channel of constant cross section, avoiding a deceleration of the fuel flow and thus avoiding such energy losses.

The present invention provides also a method of manufacturing a fuel injector, said fuel injector comprising an injector body having a spray aperture; a pintle extending within the injector body for axial movement between a closed position, wherein a head of the pintle engages a valve seat of the spray aperture to seal the spray aperture, and an open position, wherein the pintle head is spaced from the valve seat to permit fuel to flow through said spray aperture, said pintle head comprising a tapered portion engageable against the valve seat of the spray aperture and a cylindrical portion upstream of said tapered portion, said method comprising the steps of providing an annular channel defining a first part of a flow passage upstream of the spray aperture, and providing a discontinuity downstream of the annular channel and upstream of the spray aperture to generate cavitation when the pintle stroke exceeds a predetermined limit to thereby generate a virtual channel of constant cross section downstream of the annular channel whereby the flow rate of the fuel flowing through said spray aperture is substantially independent of the stroke of the pintle when the pintle is in its open position.

Advantageously, the relative dimensions of the annular channel, the discontinuity, and the gap between the valve seat and the tapered portion of the pintle head when the pintle is in its fully open position are selected as a function of one or more physical property of the fuel to be injected in order to generate said cavitation downstream of said annular channel. Said one or more physical properties of the fuel comprise one or more of the fuel vapour pressure, density and the fuel viscosity.

### BRIEF DESCRIPTION OF THE DRAWINGS

An embodiment of the present invention will now be described, by way of example only, with reference to the accompanying drawings, in which:

FIG. 1 shows a known injector nozzle as discussed above;

FIG. 2 shows an injector nozzle of a fuel injector according to a first embodiment of the present invention;

FIG. 3 comprises a graph of flow rate with respect to pintle stroke for the known injector of FIG. 1 and for the injector nozzle of FIG. 2,

FIG. 4 shows a detailed sectional view of the injector nozzle of FIG. 2 showing a cavitating zone in a flow of fuel through the nozzle; and

FIG. 5 shows an injector nozzle of a fuel injector according to a second embodiment of the present invention.

### DESCRIPTION OF THE PREFERRED EMBODIMENTS

A fuel injector nozzle has two functions:
1—To deliver the right amount of fuel in the combustion chamber (metering).
2—To generate a spray suitable for the combustion.

For the known injectors, the dependence of the static flow rate (i.e. flow rate with the injector fully open) on the injector stroke is too high.

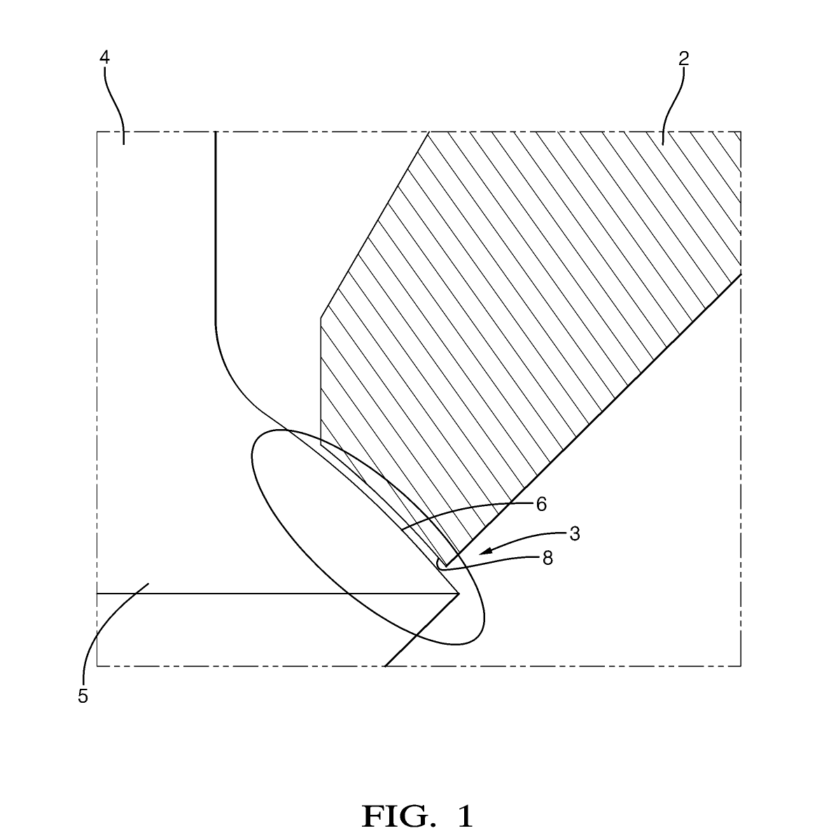

With the known fuel injectors, the flow rate variation is 1 g/s per μm stroke (3.3% of the nominal value). To ensure reliable operation and to avoid excessive variation in the fuel flow rate caused by variation in the maximum pintle stroke due to manufacturing tolerances and thermal effects and valve wear, the injector specification requires a variation of the flow rate of no more than 2% per μm lift. The current nozzle design (shown in FIG. 1) does not meet such requirement as the metering flow area is directly link to the injector stroke and its variation is 3.4% per μm stroke variation.

The present invention achieves the objectives of improving the metering accuracy and maintaining the good spray characteristics by generating cavitation upstream of a tapered portion of the pintle head generating a virtual flow channel of constant cross section between the pintle head and the valve seat to prevent changes in the flow rate of fuel through the injector nozzle.

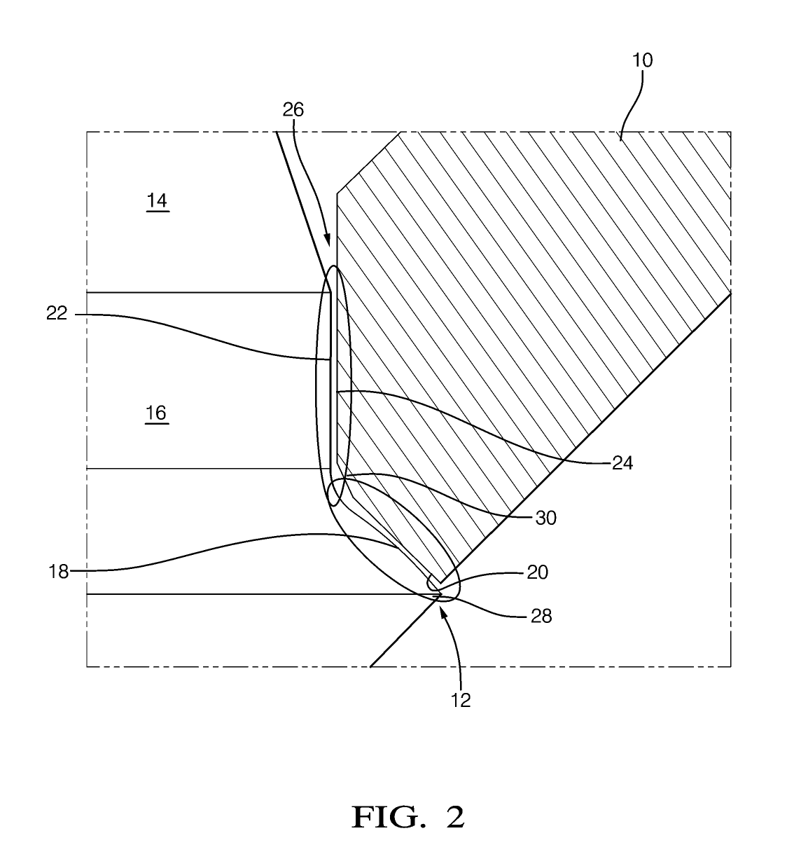

As shown in FIG. 2, the fuel injector comprises an injector body including a tip portion 10 having a spray aperture 12 at a distal end thereof. A pintle 14 extends within the tip portion 10, the pintle 14 having a head 16 provided with a tapered sealing portion 18 engageable with a correspondingly tapered valve seat 20 surrounding the spray aperture 12 to close the spray aperture 12.

The pintle 14 is axially moveable within the tip portion 10 between a retracted position, wherein a region of the tapered sealing portion 18 of the head 16 engages the valve seat 20 to close the spray aperture 12, and an extended position, wherein tapered sealing portion 18 of the head 16 is spaced from the valve seat 20. A return spring is typically provided to bias the pintle 14 towards its retracted position.

Typically an end stop (not shown), defined by an upper end of a tubular sleeve or pintle guide cooperates with a collar on the pintle 14 to limit the extension of the pintle and define the stroke of the pintle.

A solenoid actuator (not shown) having an electromagnetic coil and a moveable armature may be provided to selectively urge the pintle 14 to its extended position.

Upstream of the tapered sealing portion 18 of the head 16 of the pintle 14 there is provided a cylindrical portion 22 which cooperates with a concentric inner wall region 24 of the tip portion 10 to define an annular flow channel 26 for accelerating and channelling the fuel flow between the pintle head 16 and the wall region 24 when the pintle 14 is in its fully open position. A discontinuity is formed at the downstream end of the annular flow channel 26 to cause the fuel flow to detach from a wall of the channel and thus cause cavitation. In the embodiment shown in the drawings, this discontinuity is defined by a chamfered surface 30 of the wall region 24 of the tip portion 10, upstream of the valve seat 20. However, a step or any other formation enabling flow detachment and thus the generation of cavitation may be utilised and the discontinuity may be formed on either one or both of the pintle head and the tip portion of the injector body.

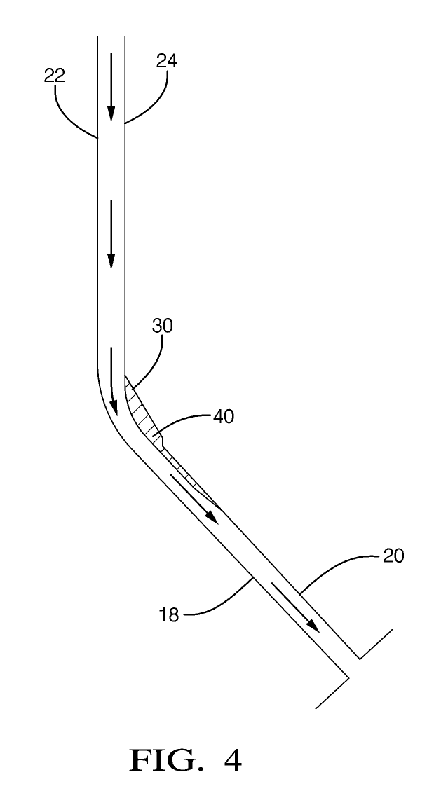

The chamfered surface 30 generates a cavitating zone 40 (as shown in FIG. 4) when the pintle stroke exceeds a critical stroke value due to fuel detaching from the chamfer edge and creating a low pressure region wherein the liquid fuel vaporises. This has two positive effects:
1. The size of the cavitating zone 40 increases with increasing pintle stroke so that the flow rate past the valve seat remains constant once the stroke exceeds the critical value.
2. Because of the cavitating zone 40, the flow does not decelerate downstream of the annular gap. This is important because when increasing the pintle stroke the flow area between the tapered pintle head and the valve seat increases and the flow velocity would normally decrease. By providing a cavitating zone 40, the flow area is in part filled with liquid fuel and in part filled with fuel vapour having a much lower density than the liquid fuel. As the cavitating zone 40 grows with increasing pintle stroke, the flow area occupied by the liquid fuel remains substantially constant so that the flow velocity remains substantially constant. This allows the metering of fuel flow with the minimum of energy loss (the only energy loss occurs in the gap).

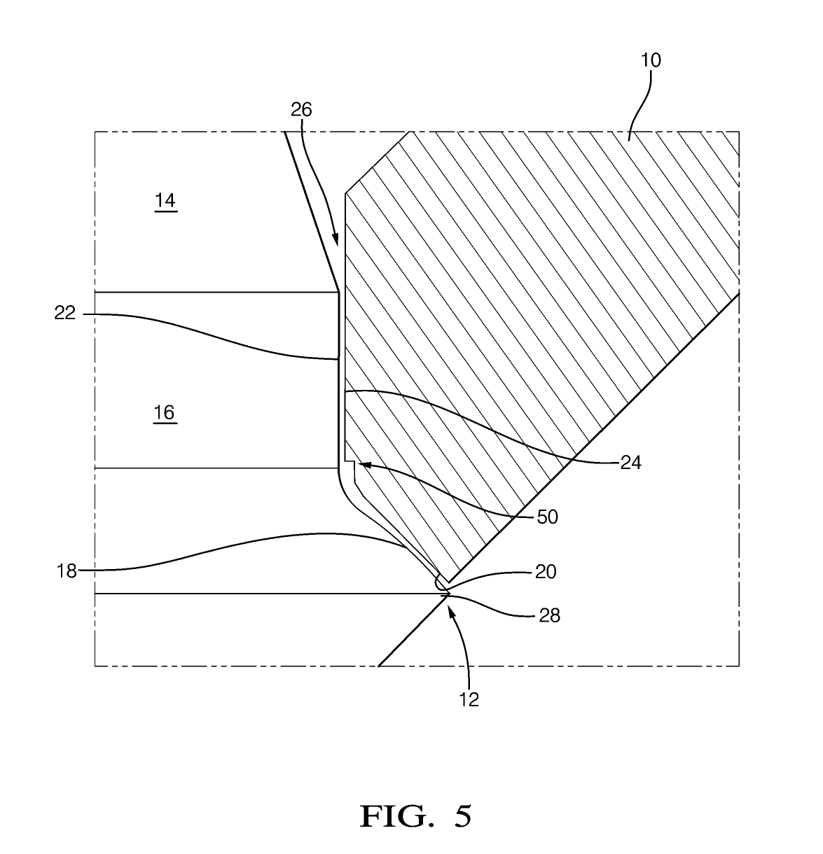

While a chamfered surface is described for generating the cavitating zone 40, it is envisaged that other geometric features downstream of the gap may be used to generate the cavitating zone. For example, the cavitating zone may be generated by a step 50 (as shown in FIG. 5) or other discontinuity on the pintle head or on the valve seat profile. The step 50 may be easier to manufacture, taking into account the very small dimensions and tolerances in the tip portion 10 of the injector body.

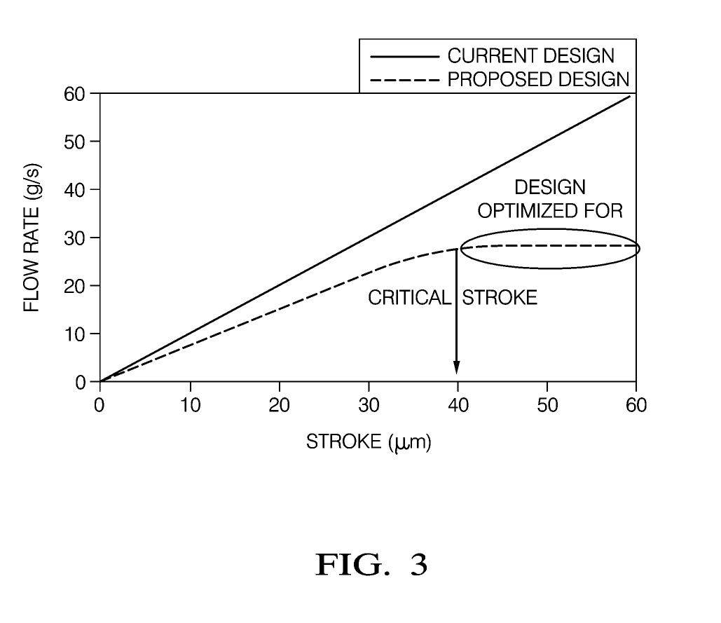

FIG. 3 shows the improvements in terms of dependence of the flow rate versus stroke variation. With the existing nozzle design the flow rate increases linearly with the stroke, while with the proposed according to the present invention there is a stroke value (critical stroke) above which the flow becomes almost independent from the stroke. The require maximum flow rate can be calibrated for a particular application by appropriate selection of the relative dimensions of the discontinuity, the clearance between cylindrical portion between the pintle head and the valve body and the stroke and these dimensions can be changed depending on customer requirements.

In conclusion, with the proposed nozzle design, the static flow rate is less sensitive to the stroke variation (flow rate variation <2% per μm) and it is possible to adjust the nominal static flow rate based on the customer needs by changing the abovementioned relative dimensions without affecting the spray characteristics.

A method of manufacturing the above described fuel injector comprises the steps of providing an annular channel 26 defining a first part of a flow passage upstream of the spray aperture 12, and providing a discontinuity 30, 50 downstream of the annular channel 26 and upstream of the spray aperture to generate cavitation when the pintle stroke exceeds a predetermined limit to thereby generate a virtual channel of constant cross section downstream of the annular channel 26 whereby the flow rate of the fuel flowing through said spray aperture is substantially independent of the stroke of the pintle when the pintle is in its open position.

Advantageously, the relative dimensions of the annular channel 26, the discontinuity 30, 50, and the gap between the valve seat and the tapered portion of the pintle head when the pintle is in its fully open position are selected as a function of one or more physical property of the fuel to be injected in order to generate said cavitation downstream of said annular channel. Said one or more physical properties of the fuel comprise one or more of the fuel vapour pressure, density and the fuel viscosity.

Various modifications and variations to the described embodiments of the inventions will be apparent to those skilled in the art without departing from the scope of the invention as defined in the appended claims. Although the invention has been described in connection with specific preferred embodiments, it should be understood that the invention as claimed should not be unduly limited to such specific embodiments.

1. A fuel injector comprising an injector body having a spray aperture; a pintle extending within the injector body for axial movement between a closed position, wherein a head of the pintle engages a tapered valve seat of the spray aperture, said tapered valve seat surrounding the spray aperture, to seal the spray aperture, and an open position, wherein the pintle head is spaced from the valve seat to permit fuel to flow through said spray aperture, actuating means being provided for selectively moving the pintle towards its open position; said pintle head comprising a tapered portion engageable against the correspondingly tapered valve seat of the spray aperture and a cylindrical portion upstream of said tapered portion, an annular channel being provided defining a first part of a flow passage upstream of the spray aperture, wherein a discontinuity is provided downstream of the annular channel and upstream of the spray aperture to generate cavitation when the pintle stroke exceeds a predetermined limit to thereby generate a virtual channel of constant cross section downstream of the annular channel whereby the flow rate of the fuel flowing through said spray aperture is substantially independent of the stroke of the pintle when the pintle is in its open position.

2. A fuel injector as claimed in claim 1, wherein said annular channel is defined between a substantially cylindrical portion of the pintle and a concentric portion of the injector body.

3. A fuel injector as claimed in claim 2, wherein said discontinuity is provided on the pintle head between the cylindrical portion and the tapered portion thereof.

4. A fuel injector as claimed in claim 2, wherein said discontinuity is provided on the injector body between the concentric portion thereof and the valve seat.

5. A fuel injector as claimed in claim 1, wherein said discontinuity comprises a chamfered surface.

6. A fuel injector as claimed in claim 1, wherein said discontinuity comprises a stepped surface.

7. A method of manufacturing a fuel injector, said fuel injector comprising an injector body having a spray aperture; a pintle extending within the injector body for axial movement between a closed position, wherein a head of the pintle engages a valve seat of the spray aperture to seal the spray aperture, and an open position, wherein the pintle head is spaced from the valve seat to permit fuel to flow through said spray aperture, said pintle head comprising a tapered portion engageable against the valve seat of the spray aperture and a cylindrical portion upstream of said tapered portion, said method comprising the steps of providing an annular channel defining a first part of a flow passage upstream of the spray aperture, and providing a discontinuity downstream of the annular channel and upstream of the spray aperture to generate cavitation when the pintle stroke exceeds a predetermined limit to thereby generate a virtual channel of constant cross section downstream of the annular channel whereby the flow rate of the fuel flowing through said spray aperture is substantially independent of the stroke of the pintle when the pintle is in its open position.

8. A method as claimed in claim 7, wherein the relative dimensions of the annular channel, the discontinuity and the gap between the valve seat and the tapered portion of the pintle head when the pintle is in its fully open position are selected as a function of one or more physical property of the fuel to be injected in order to generate said cavitation downstream of said annular channel.

9. A method as claimed in claim 8 wherein said one or more physical properties of the fuel comprise one or more of the fuel vapour pressure, density and the fuel viscosity.
